(19) United States
(12) Patent Application Publication
(10) Pub. No.: US 2007/0244785 A1
(43) Pub. Date: Oct. 18, 2007

(54) METHOD AND SYSTEM FOR ANALYSIS OF A STOCK PORTFOLIO

(76) Inventor: Anthony B. Williams, Monterey, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 11/279,886

(22) Filed: Apr. 15, 2006

(51) Int. Cl. G06Q 40/00

(52) U.S. Cl. 705/36 R

(57) ABSTRACT

The present invention provides a system and a method for the analysis of a stock portfolio. The method includes establishing precision measurements of return and risk for each stock held in a portfolio. These measurements are determined by transforming the stock price of each stock into its logarithm thereby creating a logarithmic stock price, along with calculating the stock's coefficients of the straight-line trend in the logarithmic stock price that has the least error. By utilizing the logarithmic stock price and coefficients for each stock to calculate the return and risk for each stock, the return and risk of the portfolio as a whole can be measured and thereby controlled.

### REFERENCE TO PENDING APPLICATIONS

This application is not based upon any pending domestic or international patent application.

### REFERENCE TO MICROFICHE APPENDIX

This application is not referenced in any microfiche appendix.

### BACKGROUND OF THE INVENTION

1. Field of the Invention

The present invention is generally directed toward a system to measure a stock portfolio's return and risk. More specifically, the present invention is directed toward a method and system utilizing quantitative numerical methods to measure risk and return for an individual stock as well as for a portfolio of stocks.

2. Background:

The fundamental idea behind a market is profit: buy low and sell high. The fundamental idea behind a portfolio is reduction of risk (by diversification), so you can buy risk and sell return. Note that variation about the long term return is the risk, which includes price changes upward as well as downward. The efficiently learning market hypothesis and the capital asset pricing model hold that prices eventually reflect the fact that a high risk demands a high return

The stock in a well run corporation may traverse a predictable path. A start-up company might appear to have high risk and low return, hence a low price at a good time to buy in. Since risk includes the possibility of the stock price going up as well as down, we expect a stock that performs well to begin moving upward as its price increases (and hence its return). As the company matures, it is expected for its return to reach some stable growth rate, and risk to decrease as managers become better at controlling the company's performance. Eventually, most companies will experience a falling return (and increasing risk) establishing a good time to sell that company's stock.

Investors want to purchase a moderately risky stock (at a low price) with moderately good prospects of achieving a higher return, at which point they can sell (at a high price) and start over with something else. By maintaining a well balanced portfolio, investors minimize risk. The minimized risk that results from holding stocks in a diverse portfolio then allows an investor to accumulate more risky stocks (with higher potential return) than could be tolerated individually.

Prior art attempts have been made to control aportfolio's return and risk. Traditionally, these prior art attempts have analyzed stocks as distributed among market sectors (however defined), at large or small capitalization, growth or value, and domestic or international allocations. These prior art attempts, however, have disadvantages and are inherently non-precise and even inaccurate metrics. These prior art attempts are not very successful because they are qualitative, arbitrary, judgmental and lack a firm basis for measurement grounded in the applicable statistics. The lack of good statistical practice prevents robust detection of significant behavior of a stock or of a portfolio.

Regarding analyzing stocks as distributed among market sectors, the prior art answer to the question “to which sector does this stock belong” seems based upon superficial similarities rather than actual measurement. For example, the GATX Corporation (GMT) is classified by BetterInvesting as in the Financial Sector, by MSN as in the Rental & Leasing Services Industry. In fact, GATX finances and leases most of the nation's railroad tank cars, many airplanes, and operates a large Great Lakes shipping fleet, so its stock most often behaves as if in the Transportation Sector, reflected by its membership in the Dow Jones Transportation Average. The problem with the prior art is that grouping by Sector or Industry is a judgment, and can be arbitrary.

Regarding analyzing stocks with respect to large or small capitalization, the prior art's distinction between large cap and small cap is quite mechanical, solely based upon two thresholds for share price times number of shares, “capitalization”, at small-cap if less than $1.5 billion, mid-cap below $8.6 billion, else large-cap. This appears to be a blunt instrument and unstable. A stock near a threshold can move back and forth between categories overnight.

Regarding analyzing stocks with respect to value and growth, the prior art distinction depends upon ratios of standard accounting variables. A “value stock” appears to have a low price compared to its dividends (“yield”), earnings or book value. These accounting variables are more or less subject to the control of the board of directors of a company, depend strongly upon traditional quarterly and annual announcements, and are subject to relatively arbitrary revision by the Federal Accounting Standards Board and other regulatory bodies, partly in the recognition of their poor quality as guides for investors. A “growth stock” appears to have a positive change in stock price for a year, with a slope greater than that of some market index such as the S&P500. The two definitions, value and growth, therefore are not complements. Finally, the relative degree to which a stock belongs to a category depends upon its rank in a sorted list, which is a weak, non-linear measurement.

The prior art attempts at control of a portfolio are weak because they do not have precise, accurate, quantitative measurements for the return and risk of individual stocks. Prior art also fails to honor correlations among the stocks in a portfolio. Although the influence of correlation is more or less well known to economists, the prior art available to the individual investor does not supply a quantitative description of the portfolio as a whole based upon measuring the individual stock return, risk, and correlations. Therefore, the prior art fails to provide a quantitative measurement of the return and risk in the portfolio itself.

Insofar as the prior art as known to the economist applies, so-called Modern Portfolio Theory or MPT, three failings are evident, in return, risk, and linearity.

The measurement of a stock portfolio's return in prior art is inaccurate because traditional measures use percentage ratio of price from day to day, thus: a price on Wednesday of $17.05 followed by a price of $18.23 on Thursday has a day-to-day return of ((18.23−17.05)/17.05)*100%, or 6.921%. This is not a satisfactory statistical variable because it is asymmetrical. If the stock now has a loss of 6.921% on the next day, it closes at $16.97 on Friday, not $17.05.

Over longer periods, say, annually, a similar calculation depends entirely on the two data points at the start and the end of the period, and is therefore not a robust measurement; changing the dates can lead to dramatic swings in return. Furthermore, the fine detail in the day-to-day returns are ignored in calculating the annual return, so the annual measurement is inefficient; it does not make use of all the available data.

Additionally, the measurement of risk in prior art is seldom presented to the individual investor as other than a broad qualitative judgment. There are no good quantitative measurements of risk available to the individual investor, in part because traditional measures use variation of price about the arithmetic mean of return. Not only are the returns themselves erroneous because of the percentage measure in the prices (and the returns calculated from them), returns do not have the statistical distribution for which the arithmetic mean is suitable.

The arithmetic mean is a good average for a two-sided population with a so-called normal distribution. This prior art mean is not a good average for a one-sided population with a log normal distribution. Since there is no market for a stock with a zero or negative price, prices are necessarily one-sided, and cannot be characterized accurately by the arithmetic mean. The result is that the variation of price about such a mean does not accurately estimate correlation, as used in MPT.

Regarding linearity, the prior art is lacking because of the use of price as the variable of interest, and the statistical distribution problem set out above prevents price itself from being linear. This means that any attempts at the use of linear methods of analysis, such as removal of a linear trend or application of Fourier transform or eigenanalysis are contaminated at the start.

The prior art also fails to provide details of cyclical or seasonal behavior to the individual investor. Although occasionally mentioned in financial journals and newspapers, cyclical with the sense of “business cycle” from boom to bust, seasonal as “winter, summer”, there are no quantitative measurements of these influential features of the market. In part, this may derive from the failure of Fourier analysis resulting from non-linear data used in prior art.

The prior art also fails to employ the well-known concept of statistical significance, partly because good practice in statistics is not followed. Prior art ignores the question of the distribution of prices, returns, risks, correlation coefficients, and other populations of interest to the individual investor.

Moreover, the prior art fails to provide the individual investor with usefully attainable goals. The heart of the Capital Asset Pricing Model known to economists is the so-called Efficient Frontier, sometimes presented to investors as a desirable locus for a portfolio. It is, however, a theoretical concept, assuming unlimited access to loans of “risk-free money”, with the ability to sell short any or all of the stocks in the portfolio, and to make trades for any desired dollar amount, i.e., fractional shares. None of these capabilities is available to most individual investors; brokerages demand special covenants and commitments in order to permit selling short, deemed an “aggressive” investment.

Thus, there is a need for a method and system to analyze and thereby control a portfolio's return and risk that improves upon the prior attempts.

### SUMMARY OF THE INVENTION

The present invention satisfies the needs stated above. The present invention is generally directed toward a system to measure a portfolio's return and risk. More specifically, the present invention is directed toward a system utilizing quantitative numerical methods, and incorporating interactive graphs and printed reports, to measure risk and return for an individual stock as well as for a portfolio.

In addressing the prior art shortcomings in analyzing groups of stocks, the present invention groups stocks by means of a numerical cluster analysis of a determination matrix. The clustered stocks could be grouped based on a positive correlation between those stocks.

In addressing the prior arts shortcomings in the calculation of the diversification of a stock portfolio, the present invention calculates diversification through the measurement of the correlation coefficients of each pair of stocks in the portfolio. It also alerts the user to stocks that move in similar (bad) or opposite (good) ways.

Additionally, the present invention provides these quantitative measurements by numerical analysis of the split-adjusted daily stock closing prices in a time history in order to analyze a portfolio. These analyses provide more precise, accurate and quantitative measurements for the return and risk of a portfolio.

Moreover, the present invention provides for the logarithmic transformation of price data. The essential preparations for Fourier analysis therefore can be performed in a linear space: trend removal, tapering, and correlation against sinusoids with interesting frequencies. This removes the errors created by such an analysis on non-linear data as performed in the prior art.

Still further, the present invention resolves the problem of the failure to provide the individual investor with usefully attainable goals, a short-coming in the prior art. It discloses a novel “frontier” that can be reached with just two stocks in the portfolio, varying with the level of return desired (and consequent risk), referred to as the Pair-wise Minimum Risk Boundary. By means of numerical optimization, the user can start an automatic search in the direction of a desired ratio of return to risk. The present invention finds successive improvements that may take the portfolio beyond this Pair-wise Minimum Risk Boundary, even though using all of the stocks in the portfolio, without selling short or borrowing money or loaning money. The valuable effect is to provide the investor with goals that can be achieved, with the means to achieve them.

An aspect of the present invention discloses a method for establishing precision measurement of return and risk of each stock held in a portfolio. The method thereby can measure and then improve the return and risk of the portfolio as a whole. The precision measurements result from attention to statistical methods and details of the data. The result efficiently draws the attention of the user to significant properties of the portfolio. The valuable effect is to improve ease of use and user skill in stock portfolio management.

This aspect employs a series of steps that transform the price data into a space where linear analytic tools are most effective. These successive steps provide clear signals to one or another tool to characterize the price history dataset with sensitive numerical measurements. The method further provides for the determination of any changes in the shares held in a portfolio that may move the return and risk of the portfolio in a direction that the user specifies.

Another aspect of the present invention is to provide a system to implement the above method, wherein the system incorporates the use of a computer or computer network.

Many other beneficial results can be attained by applying the disclosed invention in a different manner or by modifying the invention within the scope of the disclosure. Accordingly, other objects and a fuller understanding of the invention in addition to the scope of the invention are set forth in the detailed description of the preferred embodiments and as illustrated by the accompanying drawings.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a flowchart of an embodiment 10 of the method for the analysis of a stock portfolio of the present invention;

FIG. 2 is aflowchart of an additional embodiment 20 of the method for the analysis of a stock portfolio of the present invention;

FIG. 3 is a flowchart of an additional embodiment 30 of the method for the analysis of a stock portfolio of the present invention;

FIG. 4 is a flowchart of an additional embodiment 40 of the method for the analysis of a stock portfolio of the present invention;

FIG. 5 is a flowchart of an additional embodiment 50 of the method for the analysis of a stock portfolio of the present invention;

FIG. 6 is a flowchart of an additional embodiment 60 of the method for the analysis of a stock portfolio of the present invention;

FIG. 7 is a flowchart of an additional embodiment 70 of the method for the analysis of a stock portfolio of the present invention;

FIG. 8 is a block diagram of an embodiment 100 of the system for the analysis of a stock portfolio of the present invention;

FIG. 9 is a block diagram of an embodiment of the ingest portion of embodiment 100 of the system for the analysis of a stock portfolio of the present invention;

FIG. 10 is a block diagram of an embodiment of the analyze portion of embodiment 100 of the system for the analysis of a stock portfolio of the present invention; and

FIG. 11 is a block diagram of an embodiment of the explore portion of embodiment 100 of the system for the analysis of a stock portfolio of the present invention.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims. The invention is capable of other embodiments and of being practiced or carried out in a variety of ways. It is to be understood that the phraseology and terminology employed herein are for the purpose of description and not of limitation.

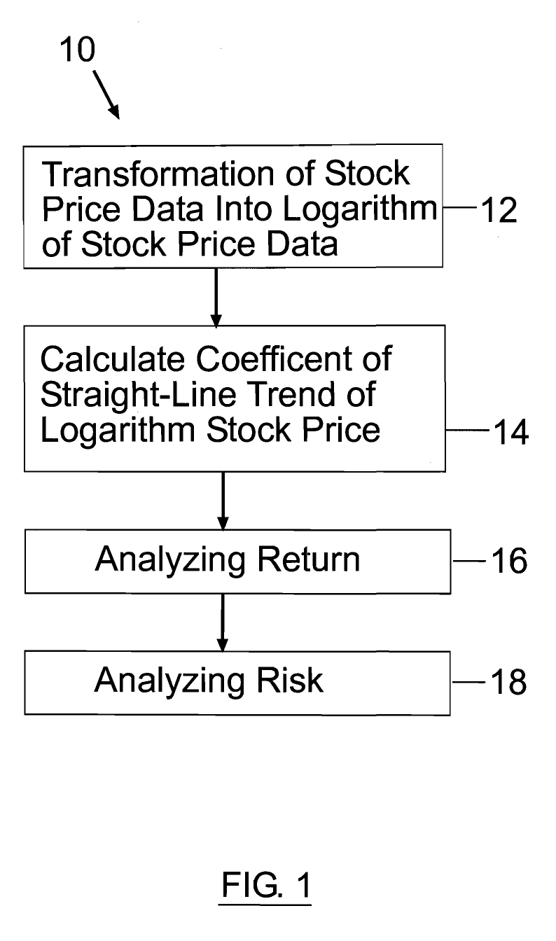

Referring now to FIG. 1 of the drawings, there is shown a method 10, which is adapted to the analysis of the stock portfolio. This method provides for the transformation of stock price data into the logarithm of that price 12, along with the coefficients of a straight line trend in the log (price) data that has the least error 14. This trend is used to define the novel return and novel risk of a stock.

As set out above, the stock market does not trade in securities with negative or zero prices. By transforming price data to log (price), the one sided distribution becomes two sided, that is, the logarithm of stock closing prices can have positive or negative values without constraint. All subsequent operations work with these logarithmic datasets. This has the effect of emphasizing relative changes in a stock (doubling or halving in value). It avoids the difficulties associated with absolute change, say, increasing or decreasing a price by $5.00, and sidesteps the problems with percentage change noted in the next section.

The distinction between two sided and one sided data is that simple statistics characterize the former with the arithmetic mean and standard deviation. These measures discriminate usual, typical and unsurprising events from unusual, atypical and surprising events. That is, the user easily can identify significant events among a normally distributed collection, given the mean and deviation of the collection. By this transformation to the logarithmic form, a lognormal distribution of price now becomes a normal distribution of log (price), so the user more easily discovers significant events.

It is known that compound interest describes most financial behavior better than simple interest does. For short time steps, this means that the price of a security tends to obey exponential growth laws. The logarithm is the formal mathematical inverse of the exponent, so logarithmic transformation of the price data permits a linear operation, removing the trend, based on the coefficients of the best fit to the time series of log (price) by the method of least squares.

Regarding the above mentioned coefficients of a straight line trend, embodiment 10 finds these coefficients in the log (price) data in a manner equivalent to the calculation of a compound interest rate.

This linear best fit trend defines novel return 16, one of the two most useful measurements of an individual stock. Prior art methods express return as the percentage change in the ratio of the price on a given day divided by the price on the previous day. Such measurements are non linear; a movement upward by 100% followed by a movement downward by 100% makes the stock worthless. The novel use of the trend in the log (price) definition for return does not have this problem. A symmetric movement up and down always returns the log (price) to its previous value. To notify the user of this special meaning, the program reports annual return as deciBels per year (dB/y). For example, +3 dB/y doubles the value of a stock in one year, 3 dB/y halves the value.

Given this trend, another linear measurement finds novel risk 18, the other of the two most useful measurements of a stock. The economics community defines risk as the standard deviation of the daily returns about the mean trend. Traditional measurement of return (percentage ratio) leads to a poor measurement of risk. The novel measurement of trend allows finding a novel risk as the standard deviation of the slopes of the log (price) about this trend. The units of annual risk also are deciBels per year (dB/y). For example, use a return of 1.5 dB/y, plus or minus a risk of 1.5 dB/y. In slightly more than two thirds of all cases, the stock could double in one year (+3 dB) or remain flat (+0 dB/y), or take any value in between. This has the same idea of precision as in specifying a distance of 100 feet as “plus or minus” one foot. Formally, it means there is less than about one chance in three that the real error in the distance is larger than the specified tolerance.

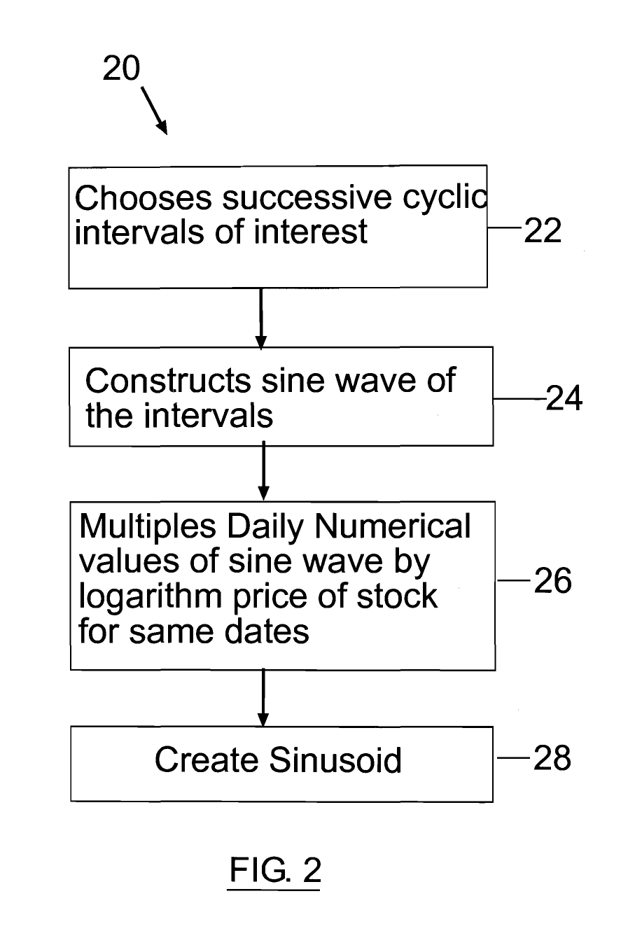

Referring now to FIG. 2 of the drawings, there is shown another embodiment 20 of the method as disclosed by the present invention. Embodiment 20 determines one or more best fits for stocks having cyclical price changes and removing them from the de trended log (price) data. This type of information is of interest to investors.

Short term changes in price might be irregular, noisy, characterized by sharp and jagged movements. Prices also can show a slow, smooth, repetitive movement as in a seasonal dependence. For example, the price of heating oil usually goes up in winter and down in the summer. Finding such cyclical stock and cycles in stock price can be of interest to investors.

Embodiment 20 searches for sinusoidal behavior with time by utilizing a Fourier analysis. More specifically, embodiment 20 chooses successive cyclic intervals of interest 22, say, in fractions of a year, and then constructs a sine wave with this interval 24. It multiplies the daily numerical values of this sine wave by the de trended log (price) of a stock for the same dates 26. These do not necessarily have a uniform time increment. If the stock price is independent of this time interval, the sum of these products is zero. If the result is non zero, then the price has a cyclic component in phase with this wave.

A cosine wave generated with the same interval measures any cyclic price component that is out of phase with the sine wave. The in phase and out of phase components together provide for all possible phase angles in log (price). This results in a single sinusoid with a phase set by a reference date and an amplitude expressed in dB$ for log (price) data 28. These parameters may indicate when a stock might be higher or lower than its trend. This embodiment 20 uses these parameters to modulate the displayed trend line and the significance envelope, so the user can judge the quality and utility of the fit.

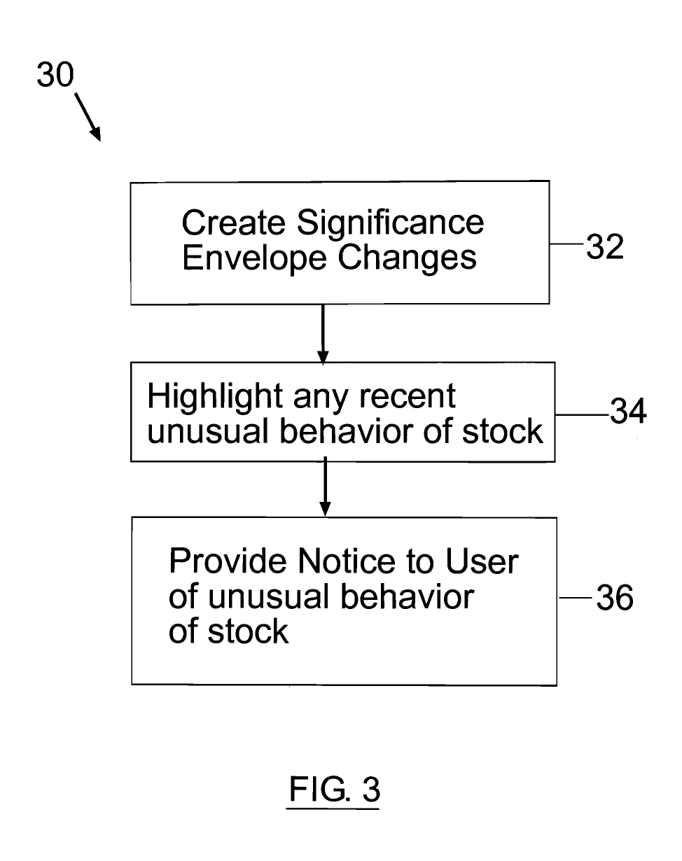

Referring now to FIG. 3 of the drawings, there is shown another embodiment 30 of the method as disclosed by the present invention. Embodiment 30 utilizes the steps set forth above along with the following steps of permitting calculation and display of a novel construction to show significantly unusual behaviors in the time history of a stock 32, a significance envelope showing accumulated departure from the trend line. This envelope denotes one standard deviation of slope (risk), departing from the trend according to the square root of the number of days since the beginning of the dataset. According to the methods of stochastic calculus, this narrow hyperbola illustrates a one-dimensional random walk in the log (price). Values inside the significance envelope are not unusual, while values falling outside the envelope deserve further investigation.

Embodiment 30 is also capable of highlighting recent unusual behavior of a stock 34. If the last known log (price) for a stock falls outside the significance envelope, embodiment 30 provides a notice to the user that the stock is behaving in an unusual fashion, and that the user should investigate the cause 36. This novel ability to focus the attention of the user on recent significant behavior improves the responsiveness of portfolio operations.

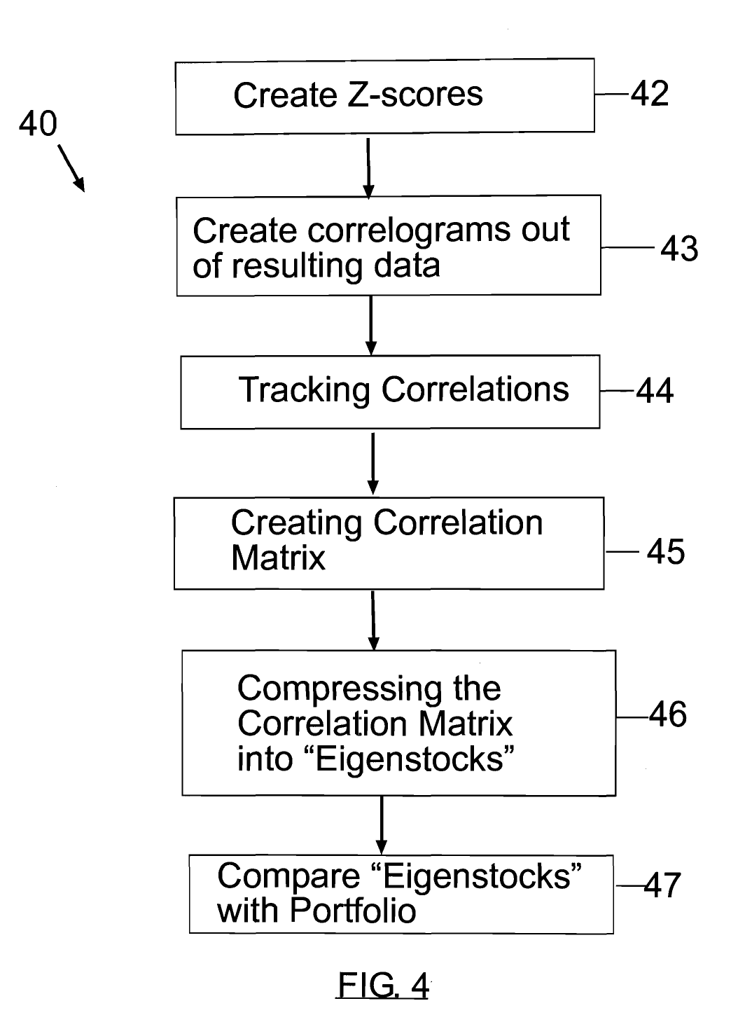

Referring now to FIG. 4 of the drawings, there is shown another embodiment 40 of the method as disclosed by the present invention. Embodiment 40 utilizes the steps set forth above along with the following steps of utilizing any remainder, or residual, movement about the trend, compare all stocks on an equal basis. This is done by transforming the residual log (price) of each stock into Z-scores as follows. These residuals have a normal distribution. It is therefore meaningful to calculate the mean and standard deviation of the residual for each stock. This transformation consists of subtracting this mean from the residual, then dividing the result by the standard deviation. This scales the dataset into units of pure significance, measured as sigma values, or Z scores.

Embodiment 40 takes a novel approach to this normalization 42. This is useful for irregular datasets, where a closing price might not be available for all days for both members of a pair of stocks. Embodiment 40 calculates the means and standard deviations only for those days that both stocks have a closing price. In a portfolio with irregular price data, any comparison of a given stock with another might therefore use a different mean and standard deviation, depending upon the days when the other stock has data.

Embodiment 40 further comprises the step of comparing price movements by creating a correlogram 43, tracking correlations 44 and creating the correlation matrix 45. After creating the correlation matrix, the resulting collection of all the normalized residual log (price) data can be compared 47. This collection of data can measure the degree to which pairs of stocks act in concert. The mean of the products of the normalized Z scores for the data where both stocks have prices is the correlation coefficient. Its range is from +1.0 (perfectly correlated: the two scores move up and down together) to 1.0 (perfectly anti correlated: the two scores move exactly opposite to one another). These coefficients have a tremendous impact upon the measurement of risk in the portfolio itself, below.

Although interesting by themselves, the correlation coefficients also form an array that characterizes the entire portfolio. Looking at every possible pair of stocks, for N stocks there are N times N such coefficients. The symmetry of the calculation guarantees that the correlation of stock I with J is the same as the correlation of stock J with I, so this matrix is symmetric about its diagonal. Since the correlation of any stock with itself on the diagonal is always +1.0, the matrix actually contains only N*(N 1) independent numbers. Embodiment 40 displays each of these values with its supporting data, consisting of the two Z score time histories and their product, called the correlogram 43.

The behavior of all N**2 N such correlograms is itself of interest. When the market as a whole changes, individual correlograms move higher. By drawing the boundaries at the mean plus and minus one standard deviation for the correlograms, embodiment 40 characterizes the events that affect the whole portfolio. Moreover, by slicing the correlation solid with histograms of the distribution of correlations at numerous dates, embodiment 40 investigates and tracks the details of these global events 44. They do not necessarily arise just from the stocks comprising the portfolio. Additionally, a correlation matrix is created from the correlations of all stocks in said portfolio 45.

The N**2 N correlation coefficients illustrate the combinatorial explosion of large portfolios. It is ideal to reduce the overwhelming mass of detail to a more manageable form. Thus, embodiment 40 illustrates an optional steps of compressing the correlation matrix into “Eigenstocks” 46 and comparing these “Eigenstocks” to the portfolio 48. These steps can be referred to as the decomposing steps. Embodiment 40 utilizes linear algebra to compress the matrix of coefficients 46 that describe the stocks into a smaller matrix that characterize “eigenstocks,” which are linear combinations of the actual stocks, chosen in order in such a way as to extract the greatest variance from the correlation matrix for each new eigenstock. This compresses the behavior of all of the stocks into the behavior of a much smaller number of “eigenstocks”, again easing the burden of diligent portfolio operations.

Embodiment 40 compares the cigenstocks with the portfolio itself, and draws the attention of the user to time intervals when a particular eigenstock recently acts most like the portfolio itself. This provide a hint about the character of the most recent changes in price. Further, once the compression of the correlation matrix 46 has occurred, the decompose steps also generates Z-scores, creates correlograms and track these correlations.

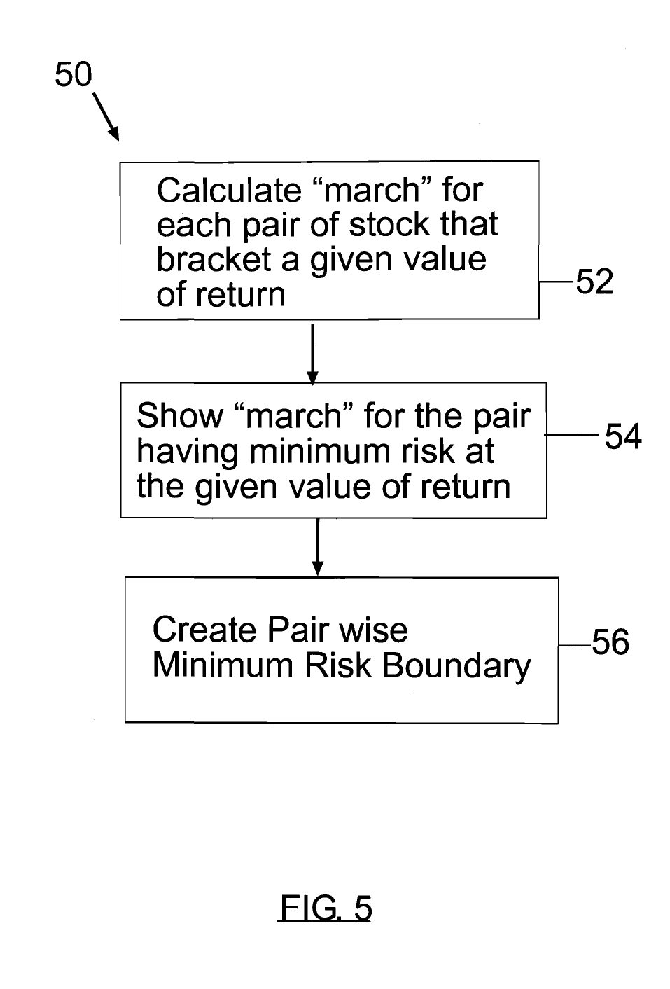

An additional embodiment 50, as illustrated in FIG. 5, incorporates the above transformations and further comprises the step of constructing a Pair wise Minimum Risk boundary 54 in order to characterize the best achievable performance.

The diligent portfolio operator is (or should be) concerned about duplicate behavior, as such fails to reduce risk, the primary purpose of the portfolio. In the same sense, pairs of stocks that show variety of movement do reduce risk and should be kept within the portfolio. The most significant such pairs are the ones that help to form the novel construction above called the Pair wise Minimum Risk Boundary to characterize the best achievable performance.

In the prior art, a correlation coefficient matrix is an element of Modern Portfolio Theory. The economics literature often illustrates this element by a curve joining the location of two stocks on a two dimensional chart of retun versus risk. This curve is referred to as a “March” in that prior art methods march a point from one stock to the other one, along the return coordinate. The march changes the proportion of the amounts invested in the end member stocks, 100% in one at its end of the curve to 100% in the other at that end of the curve.

Risk is calculated as the return varies along the March, likewise having 100% of the risk of a stock when the return is 100% of that stock (and 0% of the other). Unlike the return, the risk does not vary linearly between end points. Instead, it goes as the square root of the sums of the squares of the two end point risks, as risk is a standard deviation. There is a third term under the square root sign for two stocks. This is twice the product of the two risks and the correlation coefficient. It corrects for joint risk that does not decrease when two stocks move up and down together, but completely cancels out when two stocks move in opposite directions.

Therefore, the March between two stocks is a hyperbola, open toward increased risk. It has one limit in the case of one straight line segment joining the two end points (perfect correlation). It has another limit of two straight line segments joining the two end points to a point on the zero risk axis (perfect anti correlation). The prior art discuss this characteristic in an introduction to the Efficient Frontier, which assumes that you can sell stocks short and borrow any needed amount of risk free money.

However, the ability to do this is rare. In order to overcome this difficulty, embodiment 50 finds the March for each pair of stocks that bracket a given value of return 52 and shows the March of the pair that has the minimum risk at that return value 54, creating the Pair wise Minimum Risk boundary 56 may help. Those pairs have great influence on the least overall portfolio risk, so they are worth the attention of a diligent investor.

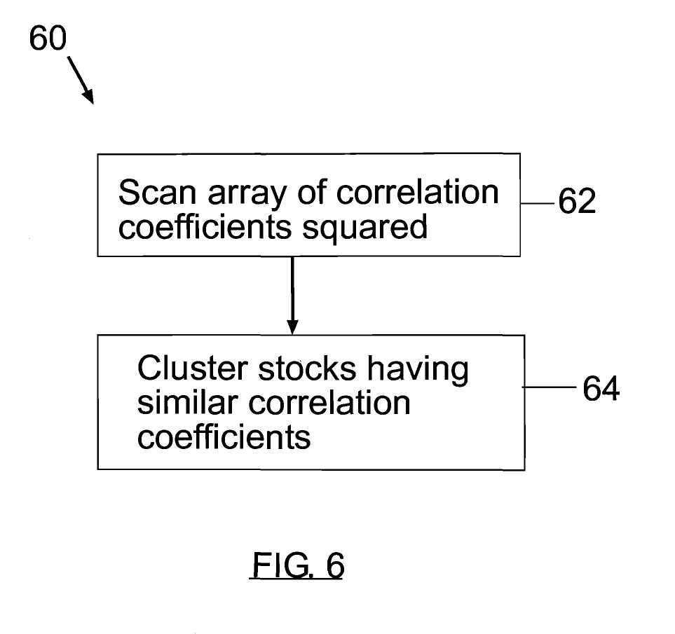

An additional embodiment 60, as illustrated in FIG. 6, incorporates the above transformations and further comprises the step of characterizing a group of stocks by analyzing stocks that cluster together by having similar relationships with all of the stocks in the portfolio. This characterization is capable of determining the distribution of similar stocks without needing someone's qualitative judgment.

Embodiment 60 treats the squares of the correlation coefficients as the elements of a square array with unit values in the diagonal, called a determination matrix, and repeatedly scans this array until there remains no single-stock clusters. Embodiment 60 scans the array after first placing every stock into its own cluster 62, then repeatedly finding the two clusters with the highest correlation coefficient between the harmonic mean of all the correlation matrix rows in each cluster, and finally joining those two clusters together 64.

Due to embodiment 60 use of the squares of the correlation matrix, this embodiment 60 clusters together those stocks that act in similar ways on all stocks, whether with a positive or a negative correlation. Embodiment 60 is capable of noting the positively correlated stocks for possible replacement of the lower return stock by the higher return stock, and also noting negatively correlated stocks for retention in the portfolio as a pair that reduce risk. The attention of a portfolio manager is drawn to the most significant of these cluster elements. These have the correlation coefficients with the greatest magnitude, regardless of sign.

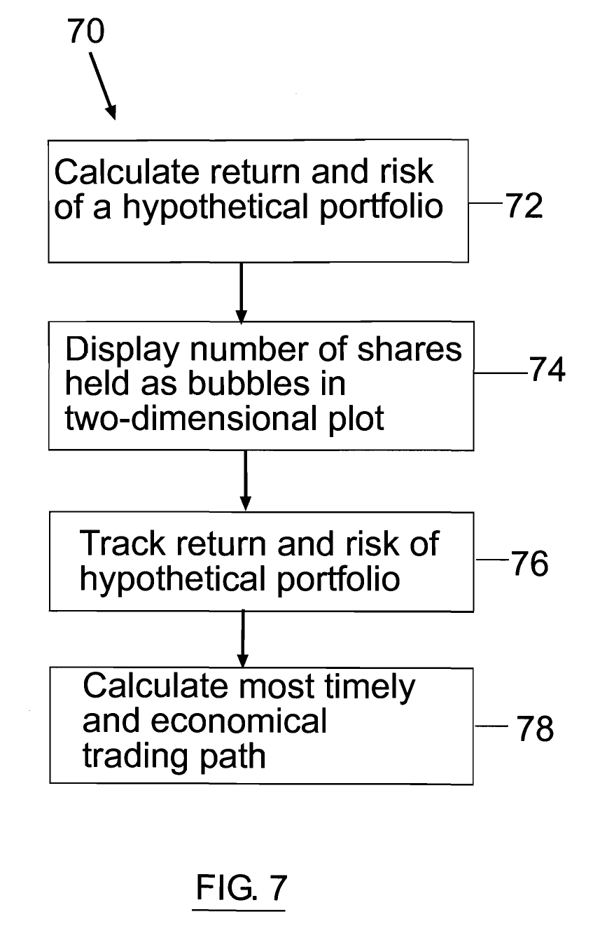

An additional embodiment 70, as illustrated in FIG. 7 incorporates the above transformations and further comprises the steps of measuring return and risk of a series of hypothetical portfolios, thereby optimizing the actual portfolio. In Embodiment 70, the step of measuring hypothetical portfolio return and risk includes the results 72 of calculating the correlation coefficient matrix from the Z scores of the de trended residual log (price) data. These results generate a more precise and useful measurement for the individual stocks, and therefore for the hypothetical portfolio as a whole. The result of feeding better inputs into Modem Portfolio Theory is a more accurate characterization of the whole portfolio.

Regarding the step of optimizing a portfolio, embodiment 70 explores vectors of pseudo random allocations of values for all the stocks held, adjusted to have the same value as the actual portfolio. Each vector uses the result of the individual stock return, risk and correlation as found above. The user provides a desired ratio of return to risk is provided. If a search direction does not lead away from this ratio, embodiment 70 explores the direction in more detail. If it does move away from this ratio set, the program reverses the search direction.

Embodiment 70 modifies the search step size to efficiently search in the specified direction. If a search step brackets a favorable return/risk, the program refines the search in the neighborhood of the potential new optimum, using a modified Newton Raphson procedure. If a local optimum is better than the last one found, the search begins again from the new optimum, along a different vector. The number of such searches can be set to accommodate the number of stocks in the portfolio, power of the personal computer, and patience of the user.

Regarding finding significant individual stocks, embodiment 70 provides a display that shows the results of implementing the above mentioned embodiments in a two dimensional return/risk coordinate space, with constant scale in units of dB/y. The display illustrated in embodiment 70, along with other displays of the present invention derive the scale of the two axes from the calculated maximum and minimum values of return and risk measured for all the stocks in the portfolio, rounded away from the center to unit value.

To better characterize the elements of the display, particularly the individual stocks, embodiment 70 shows the means and standard deviations of the return 16 and risk 18 populations. In the text output from the program, it reports the distributions of these two properties under explicit assumptions about their form. Here, returns have a normal distribution, so arithmetic mean and standard deviation are appropriate to its population. Risk, however, is a one sided variable, as with the price itself. The risks have lognormal distribution, so geometric mean and standard deviation are better measures.

The display provided by embodiment 70 and other displays provided by embodiments 50 and 60 therefore subdivides the return/risk coordinate displays with horizontal and vertical lines, respectively. The mean return appears as a black line and the mean plus and minus one standard deviation appears as two gray lines, equally spaced above and below the mean return. Similarly, the mean risk appears as a black line, a gray line on either side of it to show the standard deviations. However, the spacing looks unequal, as the lines appear at the exponential (mean plus or minus one standard deviation), as is appropriate to the lognormal distribution. Stock Ticker Symbols lying outside these limits are probably unusual, and deserve further examination

Overall, embodiment 70 calculates the return and risk of a hypothetical portfolio as a whole 72. This calculation is based upon the previously calculated returns, risks, and correlations of stocks, by varying the number of shares held in each, thus iteratively finding improvement to the hypothetical portfolio in the direction selected by the user. The changes in the number of shares held are displayed as bubbles in the same two-dimensional plot with said statistical markers 74. The return and risk of the hypothetical portfolio during the iterating improvement is then tracked 76.

Embodiment 70 then calculates and reports the most timely and economical trading path that the user could follow to obtain said improvement 78. The previously determined significant recent behavior, cyclic behavior and the return, risk, and correlation are utilized in this calculation. A trading path is then created by reporting to the user the trades in time order and economical order. Embodiment 70 claims a statistically precise estimate of improvement in the portfolio 80 utilizing the trading path. The estimate includes a portfolio value and an appropriate mean doubling time (or half-life) of the portfolio with the standard deviation of the doubling time (or half-life).

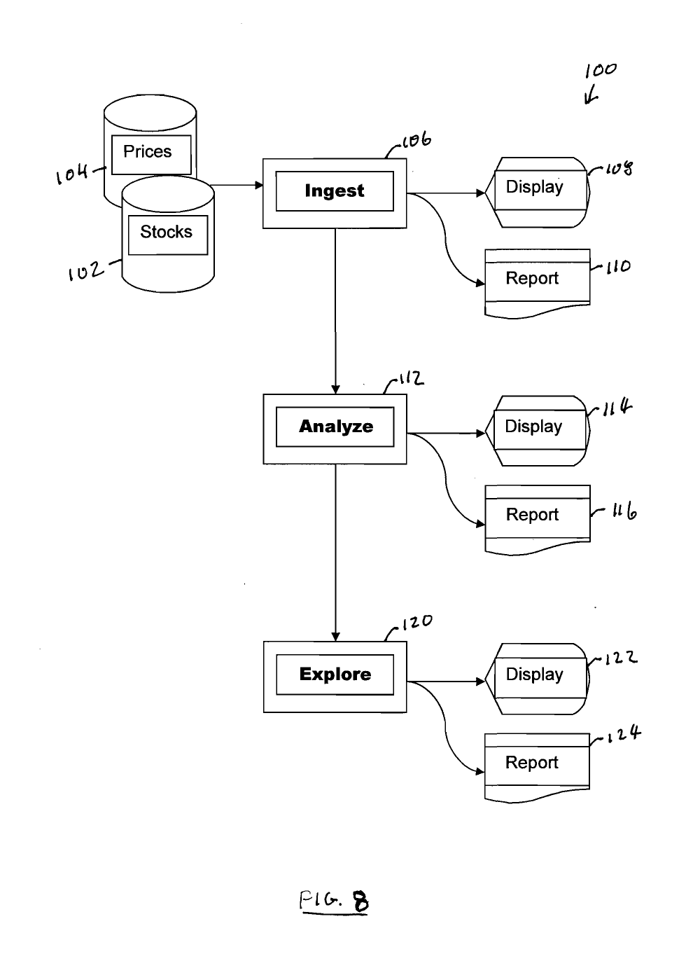

The present invention also discloses a system to implement the above method. Referring now to FIG. 8 of the drawings, there is shown a system 100, which is adapted to the analysis of the stock portfolio. This system 100 utilizes a computer to transform stock price data into the logarithm of that price, along with calculating various results therefrom. System 100 generally comprises computer code to facilitate the input of stock data from an outside source, computer code to analyze this data, and explore the analyzed data.

As illustrated in FIG. 8, stock holdings (number of stocks) data 102 and stock price data 104 are input into the system during the ingest operations 106. A display 108 of the data can be viewed, and reports 110 of the data can be created. The stock price data 104 is then analyzed during the analyze operations 112. The results of the analyzed data can be displayed 114 and report can be created 116. The analyzed data is now explored during the explore operations 120. Again, the results 122 can be viewed and reports 124 can be created.

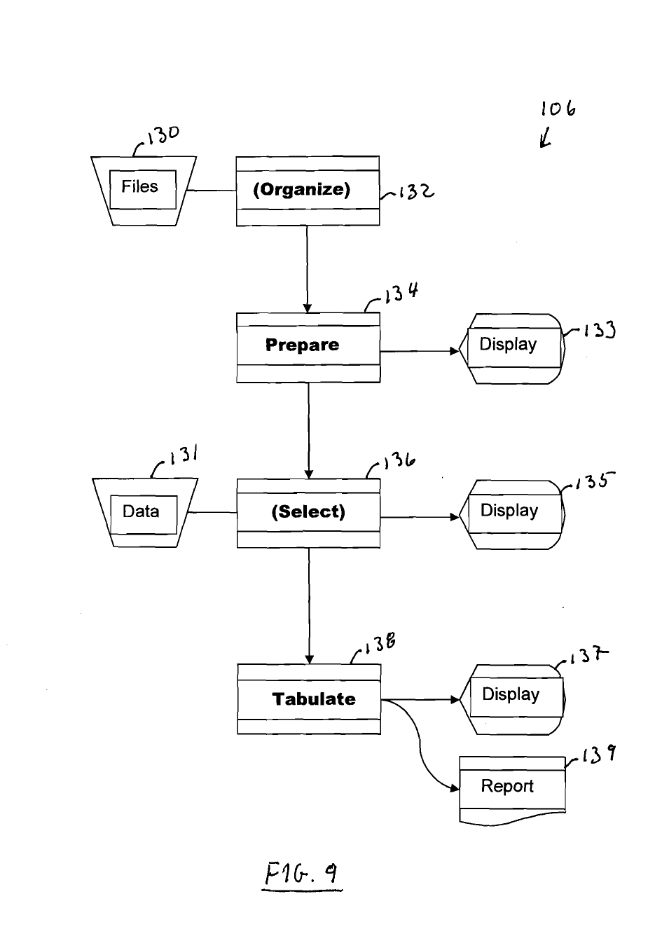

FIG. 9 illustrates an embodiment of the ingest operations 106. Stock data 131 is imported from an outside source chosen in the organization step 132 from files 130, such as: one spreadsheet-type file populated with holdings of shares in a company plus direct input of price histories via the QMatrix XLQ software engine over the Internet; one populated with holdings as above plus one with price histories; output files from third-party software such as Intuit's Quicken or Microsoft's Money programs; or output files of Transaction and Price data from the BI Portfolio Manager program.

The stock files 130, or dataset, are first organized 132 and then prepared 134 such that stock specific information, such as the name of the security, ticker symbol and transaction history (buy, split, sell), or current holdings, i.e. number of shares in each stock are associated with a specific stock. The stock data 131 and price histories are then selected 136 and tabulated 138.

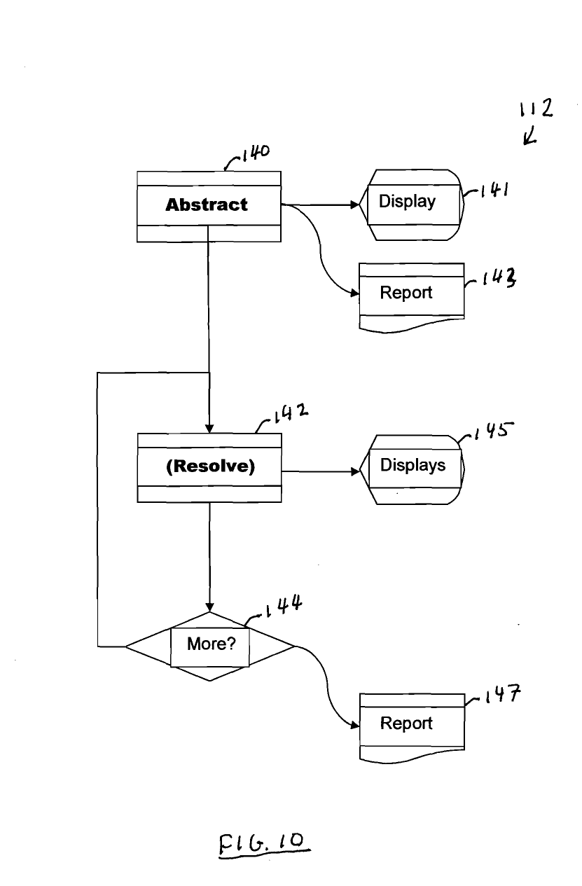

FIG. 10 illustrates an embodiment of the analyze operations 112. After the stock data 131 have been tabulated, information from each stock is then abstracted 140. This involves finding the logarithm of each split adjusted closing price to measure and remove trend over time (return), and measure scatter about this trend (risk). The present invention automatically ranks the stocks according to their return, risk, and beta(p), and reports 143 their half life or doubling time.

After the stock data have been abstracted 140, the data is optionally resolved 142 by transforming from time domain to the frequency domain. Stocks that have significant power in a particular frequency band may move up or down in characteristic cycles. Stocks may be found with similar timings and consistent phases, where the system can identify the leaders, and measure the lead time between their movements. Known cyclic behavior reduces the uncertainty in a portfolio, better isolating specific risks. This embodiment allows for the data to be resolved more than once 144.

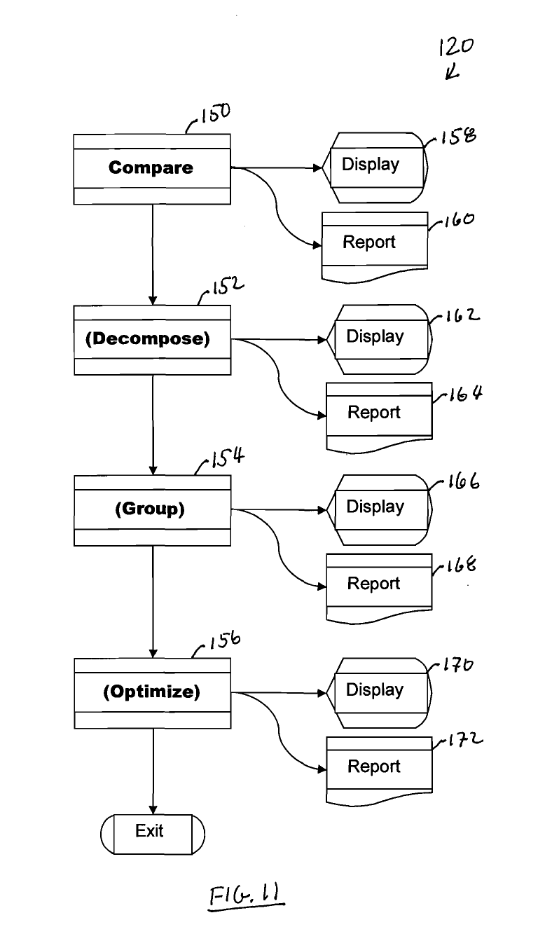

FIG. 11 illustrates the exploration operations 120 of the analyzed stock data. After the stock data has been analyzed, the user can then explore this data to discover ways to improve performance of the stock or portfolio. The user can compare stock behavior by cross correlating behavior of pairs of stocks 150; decompose these correlations to find their basis, and characteristics of behavior in parts of the portfolio 152; group stocks that cluster together with linked behaviors 154, and optimize the portfolio 156 by finding the best distribution of shares of stocks held based upon the various goals such as increased portfolio return or decreased portfolio risk.

Additionally, the system provides for various displays 158 of this information and the creation of related reports 160. Those skilled in the art will recognize that these displays and reports are not necessary the same, and that different displays and reports can be created.

Regarding the grouping of stocks, the user can discover those stocks in each cluster that move in opposite directions. These are worth keeping because they most efficiently reduce portfolio risk. Similarly, stocks can be identified in each cluster that show similar behavior. At least one of these is therefore redundant, and may be a candidate for elimination from the portfolio.

While the invention has been described with a certain degree of particularity, it is understood that the invention is not limited to the embodiments set forth herein for purposes of exemplification, but is to be limited only by the scope of the attached claims or including the full range of equivalency to which each element thereof is entitled.

We claim:

1. A method for analyzing a stock portfolio containing two or more stocks each of which having a value, comprising the steps of:
establishing precision measurements of return and risk for each stock held in a portfolio, said establishing precision measurements facilitated by transforming the stock price of each of said stock into the logarithm of said stock price thereby creating a logarithmic stock price and calculating the coefficients of the straight-line trend in the logarithmic stock price that has the least error, and utilizing said logarithmic stock price and coefficients for each stock to calculate the return and risk for each stock; and
analyzing return and risk for the portfolio as a whole based on said precision measurements of return and risk for each stock.

2. The method of claim 1 wherein said calculating said return for each stock comprises the steps of:
utilizing the method of least squares on the logarithmic stock price to determine said stock's trend, wherein said trend defines return.

3. The method of claim 2 wherein said calculating said risk for each stock comprises the steps of:
calculating the standard deviation of the slopes of the logarithmic stock price about said trend, wherein said standard deviation defines risk; and
illustrating said risk by means of a significance envelope showing the evolution of daily risk about said trend.

4. The method of claim 3 further comprising the steps of:
identifying stocks having unusual behavior by highlighting any stock whose most recent logarithmic stock price falls beyond said significance envelope.

5. The method of claim 3 further comprising the step of:
creating a first residual for each stock by subtracting said trend from said logarithmic stock price of each of said stock.

6. The method of claim 5 further comprising the steps of:
calculate the mean and standard deviation of said first residual;
subtracting said mean from said residual;
dividing said result by said standard deviation to create a dataset having units of pure significance, measured as Z scores;
creating a correlogram, said creating a correlogram is facilitated by establishing a matrix of two Z-score time histories and their product constituting a correlation coefficient;
tracking correlations;
creating a correlation matrix from the correlations of all stocks in said portfolio; and
displaying said correlation matrix.

7. The method of claim 6 further comprising the steps of:
calculating the ‘march’ between each pair of stocks in the portfolio from the measured return and risk of each stock, and said correlation matrix;
interactively displaying those marches with least risk, both individually and in composition as the Pair-wise Minimum Risk Boundary, in the a two-dimensional plot;
marking the return and risk point on the march that corresponds to the current number of shares held in each stock; and
indicating where the same return could be achieved for that pair with less risk.

8. The method of claim 6 further comprising the steps of:
compressing said correlation matrix;
decomposing said correlations by eigenanalysis into eigenstocks;
displaying the value of each eigenstock at each date;
identifying and displaying contiguous intervals of time when the values of said portfolio and values of each eigenstock are correlated;
interactively displaying those correlations of the values of eigenstocks and the values of said portfolio along with said eigenstock's and said portfolio's supporting Z-scores and resulting correlogram time histories;
measuring the significance of the eigenstock correlograms and displaying as histograms some number of the cross sections of the resulting distributions of these correlograms;
calculating the return and risk of each eigenstock;
displaying the eigenstocks according to number of shares appropriate to each stock composing the eigenstock, at their said returns and risks in a two-dimensional plot of return versus risk.

9. The method of claim 6 further comprising the steps of:
clustering stocks together based upon the squares of the said correlation matrix; and
interactively displaying these clusters, their members, and the marches between the member pairs, in the said two-dimensional plot with said statistical markers.

10. The method of claim 6 further comprising the steps of:
creating a hypothetical portfolio having the same stocks as said portfolio wherein the number of shares of the stocks making up said hypothetical portfolio are different than the number of shares of the stocks making up said portfolio;
calculating the return and risk of a hypothetical portfolio as a whole, based upon the returns, risks, and correlations of stocks;
iteratively finding improvement to the return and risk of the hypothetical portfolio by varying the number of shares of the stocks held in said hypothetical portfolio and recalculating the return and risk, wherein the last iteration of the hypothetical portfolio defines an optimal portfolio;
displaying the changes in the numbers of shares, in the a two-dimensional plot with statistical markers; and
tracing the return and risk of the hypothetical portfolio during the iterating improvement.

11. The method of claim 10 further comprising the steps of:
calculating a trading path such that said portfolio's investor can obtain said optimal portfolio, said trading path being a time ordered buy/sell list setting out the time to buy and/or sell stocks such that a positive balance is maintained;
displaying and reporting to the investor said trading path; and
claiming a statistically precise estimate of improvement in the portfolio utilizing said trading path, said estimate includes a portfolio value and an appropriate mean doubling time (or half-life) of the portfolio with the standard deviation of the doubling time (or half-life).

12. The method of claim 6 further comprising the steps selected from two or more stepsets from the group consisting of a first stepset, a second stepset and a third stepset,
wherein said first stepset comprises the steps of:
compressing said correlation matrix;
decomposing said correlations by eigenanalysis into eigenstocks;
displaying the value of each eigenstock at each date;
identifying and displaying contiguous intervals of time when the values of said portfolio and values of each eigenstock are correlated;
interactively displaying those correlations of the values of eigenstocks and the values of said portfolio along with said eigenstock's and said portfolio's supporting Z-scores and resulting correlogram time histories;
measuring the significance of the eigenstock correlograms and displaying as histograms some number of the cross sections of the resulting distributions of these correlograms;
calculating the return and risk of each eigenstock;
displaying the eigenstocks according to number of shares appropriate to each stock composing the eigenstock, at their said returns and risks in a two-dimensional plot of return versus risk;
wherein said second stepset comprises the steps of:
clustering stocks together based upon the squares of the said correlation matrix; and
interactively displaying these clusters, their members, and the marches between the member pairs, in the said two-dimensional plot with said statistical markers; and
wherein said third stepset comprises the steps of
creating a hypothetical portfolio having the same stocks as said portfolio wherein the number of shares of the stocks making up said hypothetical portfolio are different than the number of shares of the stocks making up said portfolio;
calculating the return and risk of a hypothetical portfolio as a whole, based upon the returns, risks, and correlations of stocks;
iteratively finding improvement to the return and risk of the hypothetical portfolio by varying the number of shares of the stocks held in said hypothetical portfolio and recalculating the return and risk, wherein the last iteration of the hypothetical portfolio defines an optimal portfolio;
displaying the changes in the numbers of shares, in the a two-dimensional plot with statistical markers; and
tracing the return and risk of the hypothetical portfolio during the iterating improvement.

13. The method of claim 12 further comprising the steps of:
calculating a trading path such that said portfolio's investor can obtain said optimal portfolio, said trading path being a time ordered buy/sell list setting out the time to buy and/or sell stocks such that a positive balance is maintained;
displaying and reporting to the investor said trading path; and
claiming a statistically precise estimate of improvement in the portfolio utilizing said trading path, said estimate includes a portfolio value and an appropriate mean doubling time (or half-life) of the portfolio with the standard deviation of the doubling time (or half-life).

14. The method of claim 5 further comprising the steps of analyzing a stock to determine cyclical behavior of the stock, said steps comprising:
choosing successive cyclic intervals;
calculating the PSD (Power Spectrum Density) of said first residual by means of a Fourier analysis;
fitting the PSD with an ‘orange noise’ curve, with power density increasing as the square root of time interval;
using the difference between the calculated PSD and the fitted ‘orange noise’ curve to identify the significant peak power intervals to be removed;
calculating the parameters of significant cyclic behavior, hypothetical calculated prices and dates of maximum and minimum values, and estimates of the statistical precision of these values;
displaying said cyclic behavior by modulating the said trend and said significance envelope with the same cyclic behavior; and
constructing a sinusoid with a phase set by a reference date and an amplitude expressed in dB$ for log (price) data, and then evaluate said stocks log (price) with respect to sinusoid; and
creating a second residual for each stock by subtracting said sinusoid from said first residual.

15. The method of claim 14 further comprising the steps of:
identifying stocks having unusual behavior by highlighting any stock whose most recent logarithmic stock price falls beyond said significance envelope.

16. The method of claim 15 further comprising the step of further analyzing a stock to determine cyclical behavior of the stock by replacing said first residual with said second residual calculated from the previous iteration and then creating a new second residual.

17. The method of claim 16 further comprising the step of:
reporting the parameters of significant cyclic behavior, hypothetical calculated prices and dates of maximum and minimum values, and estimates of the statistical precision of these values;

18. The method of claim 14 further comprising the step of:
reporting the parameters of significant cyclic behavior, hypothetical calculated prices and dates of maximum and minimum values, and estimates of the statistical precision of these values;

19. The method of claim 14 further comprising the steps of:
calculate the mean and standard deviation of said second residual;
subtracting said mean from said residual;
dividing said result by said standard deviation to create a dataset having units of pure significance, measured as Z scores;
creating a correlogram, said creating a correlogram is facilitated by calculating the product of two Z-score time histories;
tracking correlations;
creating a correlation matrix from the correlations of all stocks in said portfolio; and
displaying said correlation matrix.

20. The method of claim 19 further comprising the steps of:
calculating the ‘march’ associated with all possible relative number of shares held in each stock;
calculating the ‘march’ between each pair of stocks in the portfolio from the measured return and risk of each stock, and said correlation matrix;
interactively displaying those marches with least risk, both individually and in composition as the Pair-wise Minimum Risk Boundary, in the said two-dimensional plot;
marking the return and risk point on the march that corresponds to the current number of shares held in each stock; and
indicating where the same return could be achieved for that pair with less risk.

21. The method of claim 19 further comprising the steps of:
compressing said correlation matrix;
decomposing said correlations by eigenanalysis into eigenstocks;
displaying the values of each eigenstock at each date;
identifying and displaying contiguous intervals of time when the values of said portfolio and values of each eigenstock are correlated;
interactively displaying those correlations of the values of eigenstocks and the values of said portfolio along with said eigenstock's and said portfolio's supporting Z-scores and resulting correlogram time histories;
measuring the significance of the eigenstock correlograms and displaying as histograms some number of the cross sections of the resulting distributions of these correlograms;
calculating the return and risk of each eigenstock;
displaying the eigenstocks according to number of shares appropriate to each stock composing the eigenstock, at their said returns and risks in a two-dimensional plot of return versus risk.

22. The method of claim 19 further comprising the steps of:
clustering stocks together based upon the squares of the said correlation matrix; and interactively displaying these clusters, their members, and the marches between the member pairs, in the said two-dimensional plot with said statistical markers.

23. The method of claim 19 further comprising the steps of:
creating a hypothetical portfolio having the same stocks as said portfolio wherein the number of shares of the stocks making up said hypothetical portfolio are different than the number of shares of the stocks making up said portfolio;
calculating the return and risk of a hypothetical portfolio as a whole, based upon the returns, risks, and correlations of stocks;
iteratively finding improvement to the return and risk of the hypothetical portfolio by varying the number of shares of the stocks held in said hypothetical portfolio and recalculating the return and risk, wherein the last iteration of the hypothetical portfolio defines an optimal portfolio;
displaying the changes in the numbers of shares, in the a two-dimensional plot with statistical markers; and
tracing the return and risk of the hypothetical portfolio during the iterating improvement.

24. The method of claim 23 further comprising the steps of:
calculating a trading path such that said portfolio's investor can obtain said optimal portfolio, said trading path being a time ordered buy/sell list setting out the time to buy and/or sell stocks such that a positive balance is maintained;
displaying and reporting to the investor said trading path; and
claiming a statistically precise estimate of improvement in the portfolio utilizing said trading path, said estimate includes a portfolio value and an appropriate mean doubling time (or half-life) of the portfolio with the standard deviation of the doubling time (or half-life); and

25. The method of claim 19 further comprising the steps selected from two or more stepsets from the group consisting of a first stepset, a second stepset and a third stepset,
wherein said first stepset comprises the steps of:
compressing said correlation matrix;
decomposing said correlations by eigenanalysis into eigenstocks;
displaying the value of each eigenstock at each date;
identifying and displaying contiguous intervals of time when the values of said portfolio and values of each eigenstock are correlated;
interactively displaying those correlations of the values of eigenstocks and the values of said portfolio along with said eigenstock's and said portfolio's supporting Z-scores and resulting correlogram time histories;
measuring the significance of the eigenstock correlograms and displaying as histograms some number of the cross sections of the resulting distributions of these correlograms;
calculating the return and risk of each eigenstock;
displaying the eigenstocks according to number of shares appropriate to each stock composing the eigenstock, at their said returns and risks in a two-dimensional plot of return versus risk;
wherein said second stepset comprises the steps of:
clustering stocks together based upon the squares of the said correlation matrix; and
interactively displaying these clusters, their members, and the marches between the member pairs, in the said two-dimensional plot with said statistical markers; and
wherein said third stepset comprises the steps of:
creating a hypothetical portfolio having the same stocks as said portfolio wherein the number of shares of the stocks making up said hypothetical portfolio are different than the number of shares of the stocks making up said portfolio;
calculating the return and risk of a hypothetical portfolio as a whole, based upon the returns, risks, and correlations of stocks;
iteratively finding improvement to the return and risk of the hypothetical portfolio by varying the number of shares of the stocks held in said hypothetical portfolio and recalculating the return and risk, wherein the last iteration of the hypothetical portfolio defines an optimal portfolio;
displaying the changes in the numbers of shares, in the a two-dimensional plot with statistical markers; and
tracing the return and risk of the hypothetical portfolio during the iterating improvement.

26. The method of claim 25 further comprising the steps of:
calculating a trading path such that said portfolio's investor can obtain said optimal portfolio, said trading path being a time ordered buy/sell list setting out the time to buy and/or sell stocks such that a positive balance is maintained;
displaying and reporting to the investor said trading path; and
claiming a statistically precise estimate of improvement in the portfolio utilizing said trading path, said estimate includes a portfolio value and an appropriate mean doubling time (or half-life) of the portfolio with the standard deviation of the doubling time (or half-life).

27. A computer-aided system for analyzing a stock portfolio comprising,
a computer having hardware to facilitate storage of stock price data and computer code to facilitate the input of stock price data from an outside source, the transformation of said stock price data into the logarithm of that price, the analysis of said logarithmic price and the exploration of said logarithmic price.

28. The computer-aided system of claim 27, wherein said computer code is further defined as computer code to facilitate the ingest operations, computer code to facilitate the analysis operations and computer code to facilitate the exploration operations.

29. The computer-aided system of claim 28, wherein said computer code to facilitate the ingest operations further comprises:
computer code to chose files, input stock price data, to display said data and to create reports based on said data.

30. The computer-aided system of claim 29, wherein said computer code to facilitate the analyze operations further comprises:
computer code to facilitate calculation of the logarithm of each stock price, and to measure said stock's return and risk; and
computer code to facilitate the resolution of the logarithmic stock price by transforming the data from the time domain to the frequency domain.

31. The computer-aided system of claim 30, wherein said computer code to facilitate the exploration operations further comprises:
computer code to facilitate the comparison of stock behavior by cross correlating behavior of pairs of stocks.

32. The computer-aided system of claim 31, wherein said computer code to facilitate the exploration operations further comprises:
computer code to facilitate the grouping stocks that cluster together with linked behaviors.

33. The computer-aided system of claim 32, wherein said computer code to facilitate the exploration operations further comprises:
computer code to facilitate the optimization the portfolio.
